(19) United States
(12) Patent Application Publication
(10) Pub. No.: US 2016/0098624 A1
(43) Pub. Date: Apr. 7, 2016

(54) Identification notators carrying coded information and the process for using same

(71) Applicant: Conrad Louis Chompff, Concord, CA (US)

(72) Inventor: Conrad Louis Chompff, Concord, CA (US)

(21) Appl. No.: 14/121,191

(22) Filed: Aug. 11, 2014

(51) Int. Cl. G06K 19/06

(52) U.S. Cl. CPC G06K 19/06037

(57) ABSTRACT

A information bearing device into which several wires or a cable can be disposed, for the display of 2D bar code information pertaining to the wires or cable. The device includes a first engaging portion which has a flat base, and a second receiving portion for disposing the device on wire(s)/cable or other item. QR code or micro QR code or data matrix indicia concerning said item is printed on a tab which is applied to the engaging portion's flat base. Subsequent to closure, the information can be read by QR/data matrix code readers, cameras and smart phones. A clear protective cover layer may be added over the tab.

### RELATIONSHIP TO OTHER APPLICATIONS

This application is a continuation in part of Ser. No. 13/987,399, filed Jul. 23, 2013

### FIELD OF INVENTION

This invention relates to 2D bar code information bearing plastic tabs that mount on notators that can carry wires & cables used primarily in small and large computer systems, as well as larger items such as bush stems, tree trunks, prostheses and medical instruments.

### BACKGROUND OF THE INVENTION

Our computer systems at both home and at the office are getting more complex with more and more components including a multiplicity of printers for the same or plural users, and large numbers of work stations attached to a single or several servers, and multi-office phone systems, the need to follow and identify each component and each user's components becomes more complex. In industry the problems of user and component identification is even greater, with wires and cable everywhere, for work stations, phone systems, facsimiles, and networking, the modern large office and industrial IT setting is a sea of cables of all dimensions and colors, everyone of which needs to be identified now and in the future.

While oft times, all of the cables to be identified are located in one room, just as often, cables may extend to various floors of a building and even to several buildings. Thus one may not be able to follow to identify a cable coming from down the hall to the IT room, when all cables are either black or brown, and most of the same size.

In a multi-room home theater/sound setup it is next to impossible to determine which are the leads to the living-room speakers, and which go to the master bedroom. This is another of the plethora of instances, where wire and cable tracing is either not practical or is difficult to employ.

Indeed, there are of course other situations that arise in our daily lives outside of the Information Technology world wherein it would be helpful to have indicia notations pertaining to wires and cables for the purpose of giving warnings, limitations on use; directions and other information. For example wiring of differing voltages, such as 110 Volt AC versus 12 Volt DC; power lines versus speaker “cables” among others.

Many IT rooms have racks and racks of component wiring, with stacks and stacks of cables, all of which look alike. But none of which are self-identifying. Thus rack organizers have come to be to segregate cables for future easy identification. Such rack organizers are made by A “N D Cable Products, Inc. among others. While rack organizers are helpful to provide neatness, to render identification easier of any one cable, organizers organize they do not identify cables and wires. That is the job of this invention for use in large industrial and commercial settings as well as in the homes of the affluent. That is because there is a real need for a means to notate specific wires and cables with information as to their location or function.

But it is not just cables and wiring that need easy identification. Everyday products such as medical instruments, and prosthetic members need quick and easy identification modes. The invention of this application fills that need. Quick foolproof identification of laboratory samples without the need to handwrite labels that may not be readable is yet another example of the potential use of this invention.

A use in a lower technology industry for this invention is for the identification of tree specimens or bushes such as roses at horticultural nurseries, such that varieties could be separated not just by specie, but also by watering need, time to plant, depth in the ground and type of pesticide to use with the particular tree, or bush.

Whereas regular shaped such as cube or rectangular solid items, such as rail cars benefit more from the use of RFID identification schemes, irregular items of any type will more likely benefit from the use of the notators of this invention for the gathering of identification information.

### BRIEF DESCRIPTION OF THE FIGURES

FIG. 1 is a top plan view of the first embodiment of the device of this invention.

FIG. 2 is a bottom perspective view of this device's first embodiment.

FIG. 3 is a bottom plan view of the device.

FIG. 4 is a side elevational view thereof.

FIG. 5 is a top perspective view of this device.

FIG. 6 is a side elevational view taken from the Engaging side of the device.

FIG. 7 is a side elevational view taken from the Receiving side of the device.

FIG. 8 is an elevational view of the device in engaged or in use position.

FIG. 9 is a top view of the device in engaged or closed position.

FIG. 10 is a diagrammatic set of 3 views, 10A, 10B and 10C showing several moments in time of the placement of a wire/cable in the receiving portion and the movement of the engaging portion to the receiving portion to retain the wire/cable in the receiving portion.

FIG. 11 is a front elevational view of this device in closed position.

FIG. 12 is a diagrammatic representation of the QR or data matrix code carrying tabs forming part of this invention as seen on the first embodiment.

FIG. 13 is a top perspective view of the second embodiment of this invention.

FIG. 14 is a bottom perspective view of the second embodiment.

FIG. 15 is a perspective view of the second embodiment, partially in cutaway.

FIG. 16 is a magnified view of the label receiving area of the first embodiment

FIG. 17 is a magnified view of the label receiving area of the second embodiment.

FIG. 18 is a bottom perspective view of the third embodiment.

FIG. 19 is a bottom perspective view of the fourth embodiment.

FIG. 20 is a typical QR code symbol.

FIG. 21 is a typical data matrix code symbol.

### SUMMARY OF THE INVENTION

A notator adapted to be mounted directly onto individual wires and cables for the display of information pertaining to the wire or cable itself or the wires within the cable as the case may be. The notator can also be made in a larger format or size to fit around the trunk of a nursery sized tree or to fit at a defined location on an artificial arm or leg or for that matter on any irregular shaped item. The device includes a first indicia bearing engaging portion and a second receiving portion for mounting the device on a wire or cable or other article. QR code/micro QR/data matrix code indicia is added to the indicia receiving surface by placement of a self adhesive code containing tab thereon. Optionally, a protective layer over the code containing label may be added.

It is a first object of this invention to provide a device having two primary portions, one of which is for the reception of data and the other of which is for disposition on the item to be identified.

It is another object to provide an information notator that is integrated into a device that is directly mountable on a cable or wire.

It is a third object is to provide an identification notator for disposition upon generally cylindrical and tubular items.

It is a fourth object to provide an indicia notator whose first portion can be made in various sizes to receive both standard and micro-QR code information, as well as Data Matrix coded information.

It is a fifth object to provide a cable/wire/or other article substrate notator that can receive indicia by the application of pre-printed self adhesive tabs.

It is a sixth object to provide a notator for use in the medical and horticultural fields as well for the placement of identifying information thereon.

These and other objects of the invention will in part be obvious and will in part appear hereinafter.

The invention accordingly comprises the device possessing the features, properties and the relation of components which are exemplified in the following detailed disclosure and the scope of the application of which will be indicated in the claims.

For a fuller understanding of the nature and objects of the invention reference should be made to the following detailed description taken in conjunction with the accompanying drawings.

### DESCRIPTION OF THE PREFERRED EMBODIMENT

Device 10 in its first embodiment, includes a first information carrying portion 12, designated as the engaging portion, and a second receiving portion 11 that matingly engages the first portion and which second portion also receives the cable/wire or other item to be identified therein. The receiving portion 11 is fixedly attached to the first or indicia carrying portion 12 by a junction member, 60 which itself has several elements which will be described supra. For ease and convenience of the reader, all parts of the engaging portion 12 are even numbers, while all parts of the receiving portion 11 are odd numbered.

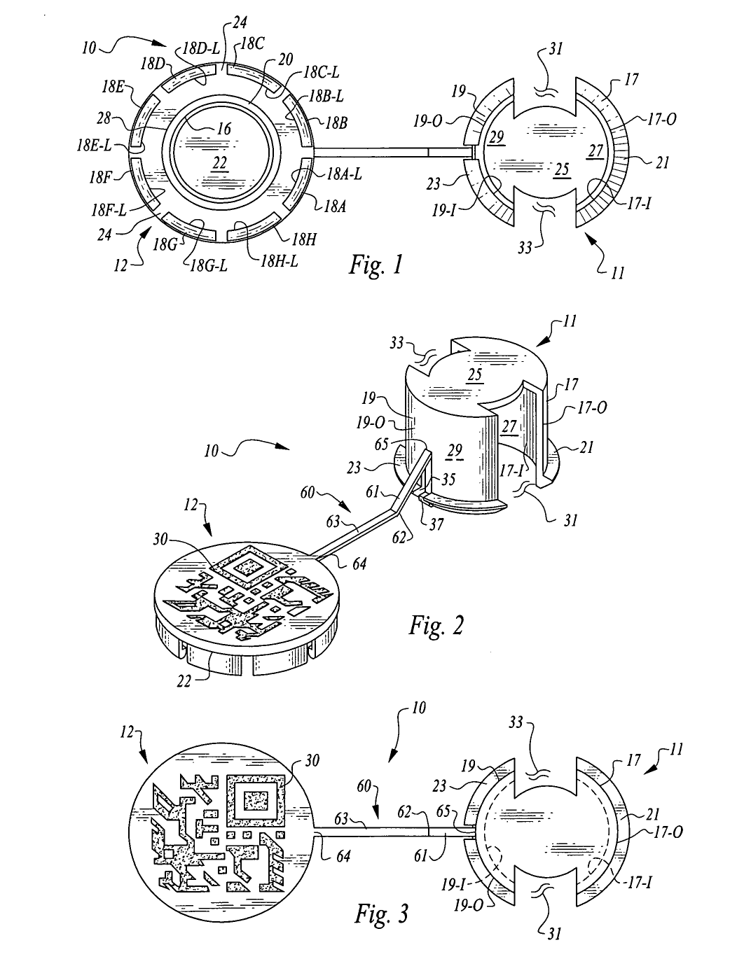

FIG. 1 depicts device 10 in a top plan view, of both the first or Engaging portion 12 and the second or receiving (retainer) portion 11. FIG. 2 is a bottom perspective view of each of these two portions as well as the flexible junction member 60 which is seen to be connected to the proximal edge of each of these. The junction member 60 is discussed in detail in the FIG. 2 description.

As seen in FIG. 1, the engaging portion 12 is round in cross section, and has a flat outer surface which is one side of element 22 while on the reverse or inner surface as seen in FIG. 1, there is a flat base 22 having a central annulus shaped segment 20, the donut hole of which is designated 26. There is a second flat area also round in configuration outside the annulus 20, and which is designated 28. Spaced from the flat area 28 at the outer edge of the base 22 is a series, here eight (8) of upstanding spaced wall segments each with an inward extending lip at the top thereof. These spaced wall segments are designated 18A-18H. Each wall segment's inward extending lip is designated with the same numerical designator followed by a dash L, such as 18F-L. The space or gap on the base 22 between each wall segment is designated 24. While 8 wall segments are shown, there is no criticality to the number which could be greater or lesser than 8 such as six or ten. It is seen that the 8 segments taken together form a multi-interruption circle. Wherein the outside wall of the circle's segments is designated 34A-34H, but only 34B, 34E and 34H have been marked to avoid clutter in FIG. 1.

The second portion 11 of this device is seen to comprise a cup-like portion having a disc base 25 and two upstanding spaced side wall segments, 17 and 19 each of which has a semi-circular base 27,29 which side wall bases, 27,29 are attached to the disc base 25 along their respective diameters. The inner surface of the wall segments are designated 19-I And 17-I respectively, while the outer surfaces as seen in FIG. 2 are designated 17-O and 19-O respectively. Each spaced wall segment 17,19 has an outward extending top lip, 21, 23, each lip having an arcuate side surface and a horizontal bottom surface normal to the wall itself. These surfaces are best seen in FIGS. 3 & 4, and designated numerically on such drawing figures.

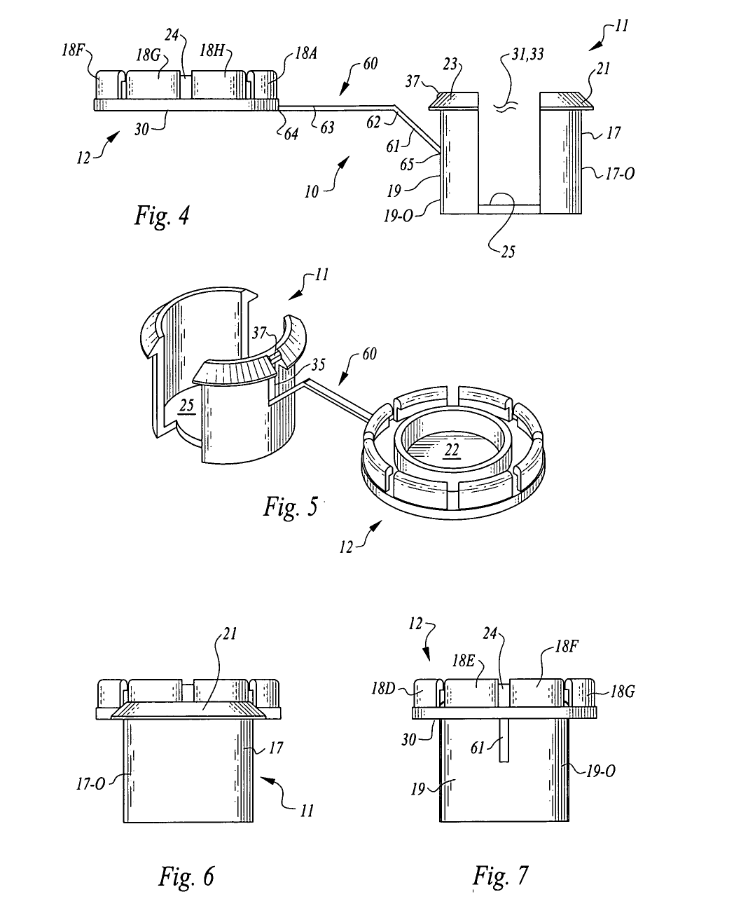

If one looks carefully at lip 23, it is seen that in the middle thereof there is a slight recess 35, which is also seen in FIG. 5, and a tiny raised bump 37 that stands upward from the lip and serves as an impact point when the two main portion are joined together. See also FIG. 4.

There are dual aligned vertical interruptions 31,33 which separate the wall segments 17,19 and which extend the full height of the wall segments, even past the base 25. These two interruptions together form a slot 31-33 for the reception of wires or cable or other items, depending upon the size of this slot. The underside of the two semi-circular bases and the underside of the disk are all in the same plane and the same elevation. By adjusting the distance between the two wall segments, 17, 19, that is adjusting the width of the interruptions 31 and 33, larger or smaller items can be carried within the notator. These spaces can be adjusted closely to fit on a single 16 gauge wire, or made larger to fit on a branch of a rose bush, or even larger to carry a prosthetic arm therein.

Let us now turn to FIG. 2. Here the details of the junction member 60 can be seen. Junction member 60 has a first shorter rod like segment 61 that is attached flexibly to the outside surface 19) of the left hemisphere 19 at about the midpoint of the elevation thereof. A longer flexible rod like member 63 is connected on one end to the shorter rod like member not at its terminus, but spaced up from the distal end (the end not attached to the surface 19-O) at point 62, and is disposed at an angle of about 120 degrees The other end of rod like member 63 is connected at the base 22 of portion 12 at the edge thereof. Notation tab 30—details of which will be set forth below in the discussion of FIG. 12 is seen disposed on the outer surface of the base 22, See also FIG. 3.

Here in FIG. 3, the connection of long rod like segment 63 at point 64 on the edge of the base 22 is seen. A viewing of FIGS. 2 & 3 together allows the reader to appreciate the shape of the lips 21, 23 with their outward extending arcuate side surface, and horizontal bottom surface, normal to the respective side wall surface.

In FIG. 4, wherein portion 12 has been rotated to the right side of the FIGURE, the raised bump 37 can be seen on the hemisphere 19's lip 23. FIG. 5 is a top perspective view that best illustrates the placement of the recess 35 in the lip 23, just below the raised bump 37. FIG. 6 is a bottom perspective view of this device in open position taken from the end of the engaging portion. Since all aspects seen in this FIGURE have been described elsewhere herein, there is no need for further discussion. The same is true for FIG. 7 which is a top perspective view taken from the opposite end of the device in open position. All of the discussion above is applicable to small notators such as used on cabling and wires, as well as large notators that would fit around a prosthetic leg or arm, and even larger notators that would fit around a two or three or even larger diameter tree as would be found at a local nursery.

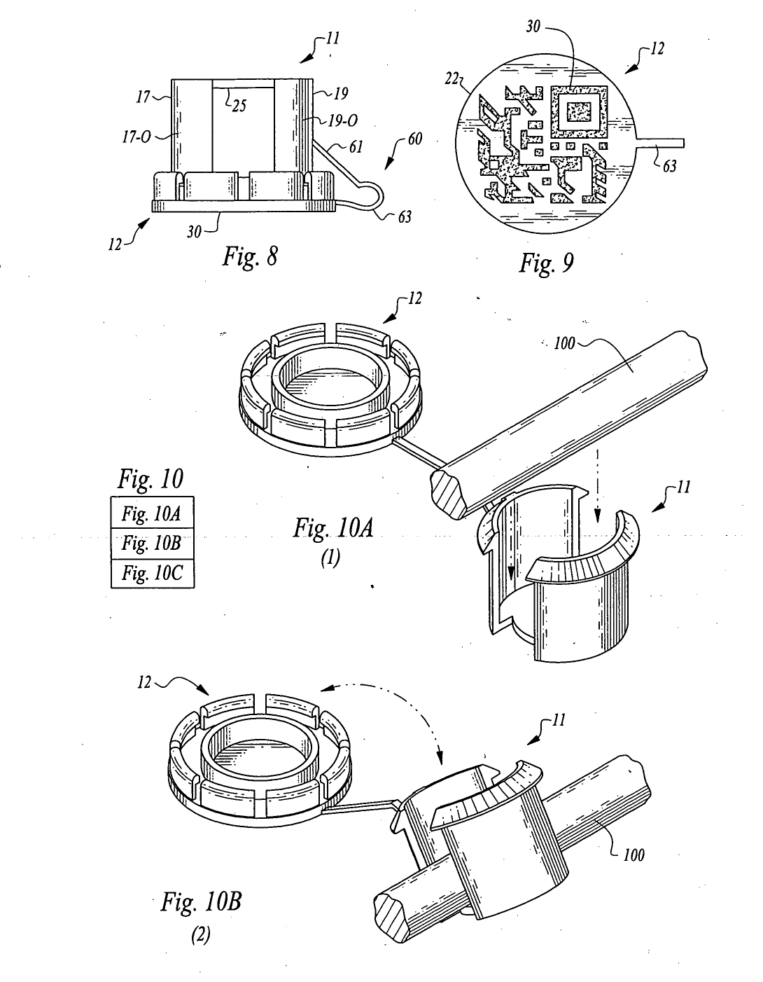

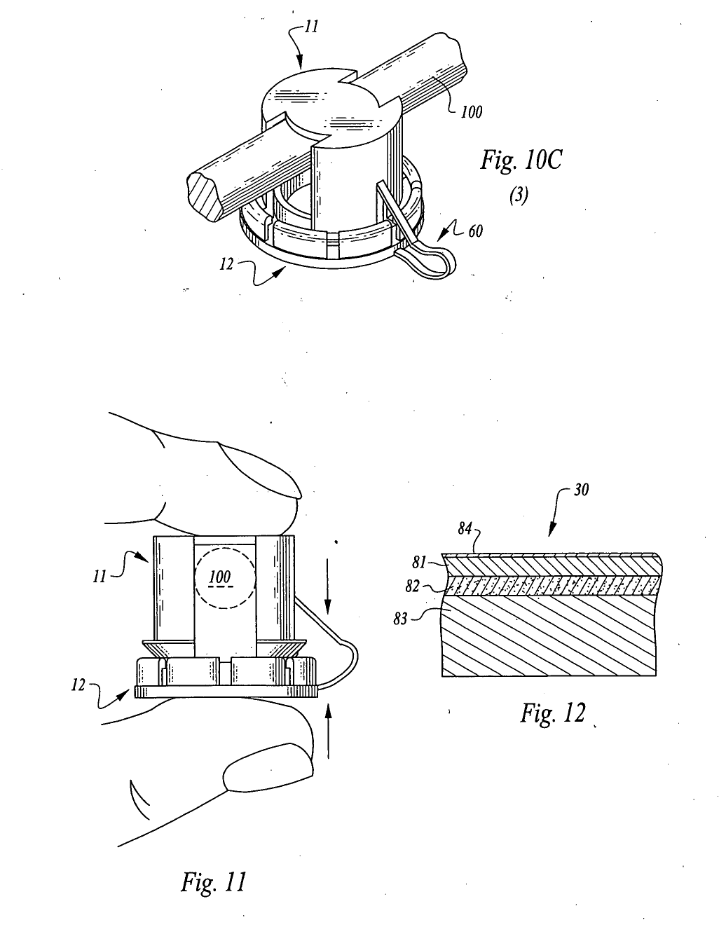

All of the discussion above has been about the device 10 when in open position prior to the disposition of wire(s) or a cable or other identified item therein. FIG. 8 is an elevational view wherein the cap or engaging portion 11 has been snapped onto the receiving portion 12 as will be illustrated in FIG. 10 a diagrammatic view of the “action”. Note how rod like member 61 has retained the same basic disposition, while flexible rod-like member 63 has rotated into an arc from its former generally flat disposition. Refer back to FIG. 2. FIG. 9 is a top plan view related to FIG. 8 in that it depicts the device in a closed position. The notation tab 30 is readily seen on what has been earlier designated as the underside of the base, 22 of the engaging portion 12. How to go from the open position as shown in FIGS. 1, 2 and 3 among others will be discussed with respect to FIG. 10.

FIG. 10 is a diagrammatic view showing the steps for securing a cable or several wires—both designated 100—within the slot 31-33 in the receiving portion 11. These steps are numbered as (1), (2) and (3). Thus the cable or wires 100 is/are placed in the slot 31-33 in the cup-like receiving portion as shown in FIG. 10 (A) The user then rotates one of the two portions toward the other as shown by the double ended arrow of FIG. 10 (B) to mate the engaging portion 12 to the receiving portion 11. Apply pressure to or one or both portions with the fingers, to dispose the lips of the receiving portion in the ring space 28—seen in FIG. 1—such that each of the inward extending lips 18A-L through 18H-L becomes disposed underneath the horizontal surface of the rims 21, 23 to secure the engaging portion to the receiving portion. See FIG. 10 (C) Thus the wires/cable or other item 100 such as the stem of a rose bush, is/are retained within the confines of the receiving portion, here 11, or 311 as the case may be, and can not escape.

FIG. 11, illustrates the application of finger pressure onto the two portions 11 & 12 to ensure engagement. It is not just a plurality of wires that can be identified by a single notator. Pair or trio of similar items, such as tree supports which are usually green elongated members 3+5 feet long, of from about ⅜ths to ¾s of an inch with spaced barbs thereon for holding string or rope from slipping down the length of the tree support. These are sold at big box store garden departments. Of course the slot 31-33 has to be enlarged as may other parts of the notator to hold several of these supports.

FIG. 12 illustrates the diagrammatically the construction of the notation tab 30 to be applied as seen in FIG. 2, which tab is constructed in a plurality of layers much like a peel and stick label available in the marketplace. Thus the lowermost layer seen here, 83 which is removed immediately prior to use, is a peelable cover layer which may contain an extended tab for fast easy removal. The purpose of the cover layer 83 is to cover over the adhesive layer 82 such that it does not stick to places where it is not desired. Such a cover layer 83 protects Band-Aid® and other branded bandages. The third layer 81 is the printable surface, capable of receiving a QR code, micro-QR code or data matrix marking. The top layer is an optional clear coat 84 to prevent the code indicia, un-numbered, from smearing or wearing off over time. Clear coat 81 may be applied by brushing on a solution of acrylic resin or dipping the device with the label attached into a bath of resin, removing and allowing the unit to dry.

Tabs bearing 2D Data Matrix code can be printed on QR code generator or similar printers available in the marketplace. Data matrix printers are also readily available. But the concept of using tiny self adhesive tabs as strata for the printing of QR and data matrix code sand applying these coded labels to substrates other than the item itself to be identified, IE to the tags employed in this invention for the identification of items on which a flat large label will not fit, is new to this invention.

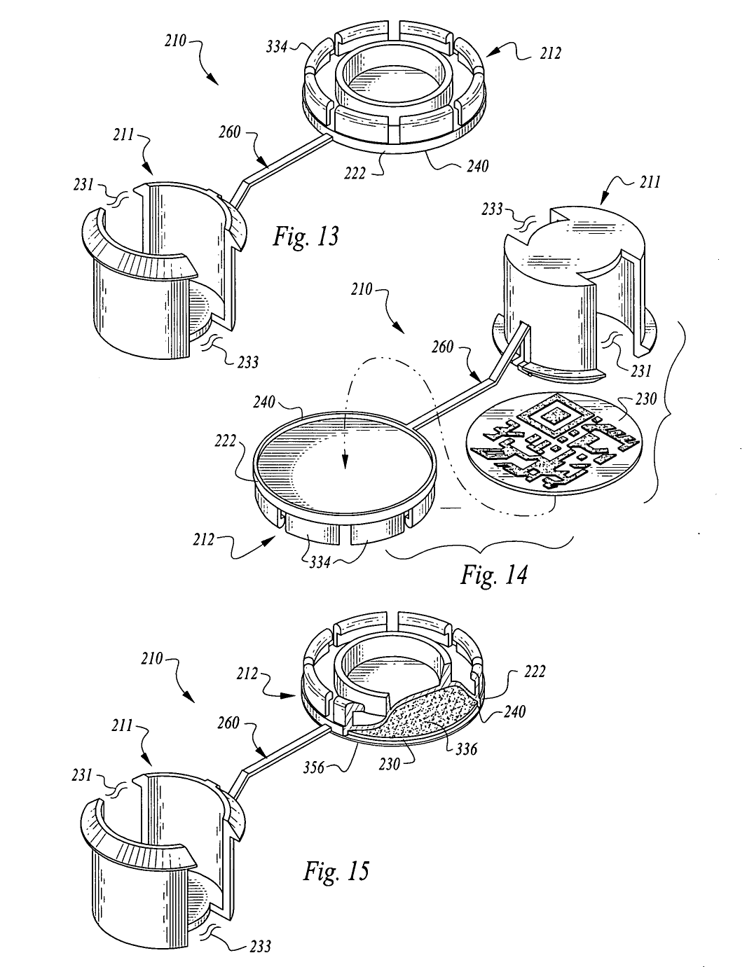

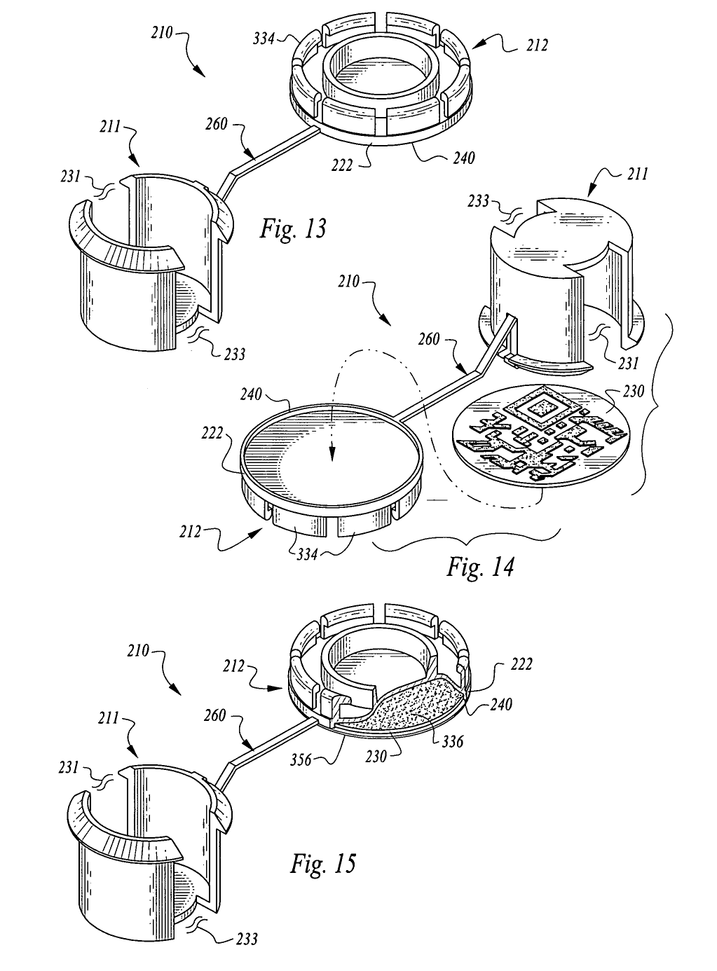

The discussion now moves to the second embodiment as seen in FIGS. 13, 14 & 15. Whereas in the first embodiment of the invention 10 employed a numbering system commencing with 12 and utilized 2 digit even numbers for the label holding engaging portion; and for portion 11, the receiving or retainer portion, two digit odd numbers. The second embodiment will utilize 210 for the embodiment, and for the portion corresponding to portion 11, it will use 211 and odd numbers and for the second portion 212 it will utilize even numbers for portion 212 that matingly engages portion 211.

The discussion now moves to FIG. 13. Here the second embodiment is seen. All of the elements of the second embodiment as seen in this view from the top are the same as those seen in FIG. 1. Since the parts as seen here in FIG. 13 are the same, only a few of the part numbers have been added but in the 200 series. Further discussion is unneeded.

However in the label receiving portion of the second embodiment, 212 as seen in FIG. 14, there are differences. The flat base 222 is the same base as 22 in FIG. 2. Whereas in FIG. 2, the tab or label 30 is seen in position, in FIG. 14 it is not in position, and in fact is shown off to the side. Portion 212 has a circular rim 240 that extends here, downwardly away from base 222 to define a base 222 that has a slightly smaller diameter than the tab mounting area of base 22. The size differential being the wall thickness of the rim 240. Thus tab or label 230 is sized slightly smaller in diameter than tab 30 in order to fit within the confines of the circular rim 240. Rim 240 is preferably an extension of the sidewall 334 segments. The rim 240 could extend laterally outwardly so as not to be flush with the sidewall segments or the rim outer edge could also not extend as far laterally outwardly as the sidewall segments 334 as may be desired. Note that rim 240 does not have the interruptions as in sidewall 334 segments.

FIG. 15 depicts the rim 240 cutaway to reveal the base 22 recessed therein as has been discussed in connection with FIG. 14. Tab/label 330 with the adhesive 336, side up and the 2D code unseen is to be disposed within the rim and then optionally sealed in place with clear cover 356. Optional cover 356, intended to protect the tab from wear and the elements, may be of acrylic or other transparent plastic, and is either press fit or glued, or heat sealed into position along its peripheral edge to the interior of the rim, 340 so as not to interfere with the legibility of the 2D code on tab 330. Cover 356 can also be added by brushing on a coat of clear resin, or by dipping the device into a resin bath and allowing it to dry.

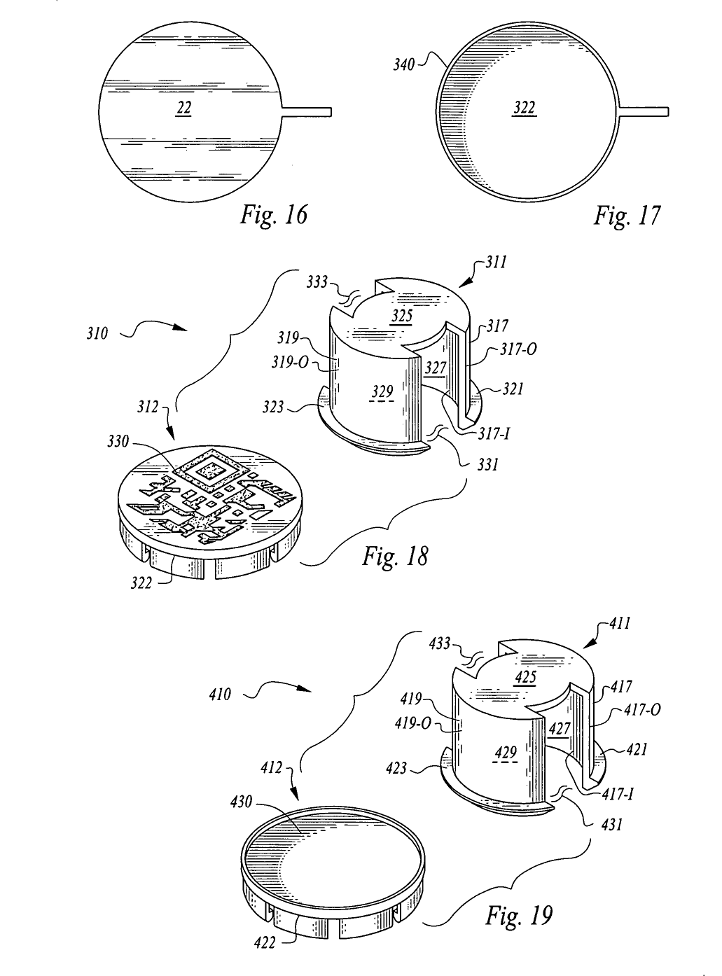

FIGS. 16 and 17 are plan views of the first and second embodiments of the tab receiving area on base 22 and 322 respectively. Due to the presence of rim 340, the diameter of the available space for a tab or label is lessened in the second embodiment.

The discussion now moves to the third embodiment as seen in FIG. 18. Whereas the first embodiment of the invention 10 employed a numbering system commencing with 12 and utilizing 2 digit even numbers for the label holding engaging portion, and for portion 11, the receiving or retainer portion, two digit odd numbers, The second embodiment utilized 210 for the embodiment, and 211 for the portion corresponding to portion 11, and odd numbers; and for the second portion 212 with even numbers, which second portion matingly engages portion 211.

FIG. 18 depicts a variant of both embodiment 1 and embodiment 2. Here the third embodiment will use 310A and 310B for the embodiment and 311 for the receiving portion, and odd numbers. But since this embodiment has differences in the engaging portion, even numbers in both the 300 series and the 400 series will be utilized. For embodiment 310A, it is to understood that all details set forth for the receiving portion are the same as discussed for the first embodiment 10 and as such all of the discussion concerning the odd numbered two digit parts are incorporated herein by reference, and are shown as such in the FIG. 18 drawing's left side.

For embodiment 310B it is also to be understood that all details set forth for the receiving portion are the same as discussed for the second embodiment 210 and accordingly the discussion concerning the odd numbered three digit parts in the 200 series are incorporated herein by reference and are shown as such in the right side of the FIG. 18 drawing in the 400 series.

The difference between the third embodiment versions, and those of the first two embodiments is the fact that there is NO JUNCTION MEMBER 61.—emphasis added—. The wire(s), cable, bush branch, prosthetic, or other odd shaped item is inserted into the receiving portion and the two portions are snapped together without having to worry about the junction member 61. See the appropriate FIGURE. It is believed that the elimination of the junction member will work better for units of this invention which are sized for relatively larger items, such as a nursery trees, elongated cylindrical containers, arms of medical instruments such as hemostats and scalpels for both human and large animal surgeries.

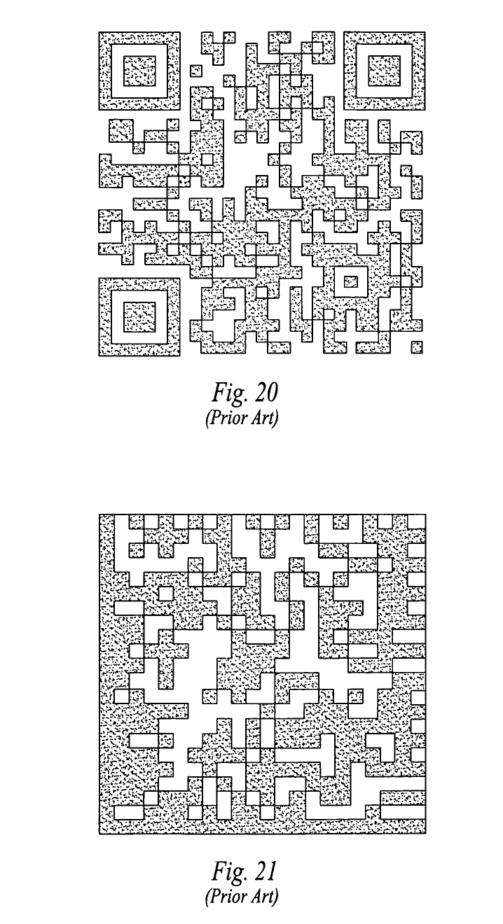

FIGS. 19 AND 20 are sample illustrations of the prior art 2D bar codes known as QR code and Data Matrix code. The images form no part of the invention, but are present only for the enlightenment of the reader.

QR code is the abbreviation for Quick Response Code. It is a type of matrix bar code first designed by Toyota Motor Car Company in Japan Bar codes are optical machine readable labels or labeling attached to items that record information pertaining to the item. QR codes have become widely adopted due to fast readability and greater storage capacity as compared to standard UPC bar codes which are just a series of numbers and sometimes letters interspersed therein. The information encoded can relate to almost any type of data, such that the coded elements of black square dots arranged in a square grid on a white background can be ready an imaging device such as a camera, smart phone, using readily available low cost software, QR code both standard and micro can be read as well by QR code readers, which can be ordered from companies on the internet such as at www.mobile-barcoes.com among others.

Data matrix code is also a two dimensional matrix bar code which consists of a series of black and white cells or modules which are arranged in either square or rectangular shaped patterns. Both text and numerical information can be encoded. The length of the encoded data depends upon the number of cells or modules in the matrix. One data matrix symbol can store up to about 3000 alphanumeric characters. If the average letter contains 80 characters per line, one can see how much information can be squeezed into a tiny space. The data matrix symbol consists of data regions which contain the above noted modules set out in an array An error correction mode can also be built into the symbol.

By putting QR code, micro QR and data matrix code information on cable organizers, and other items of a non flat nature, space can be saved by not having to attach large labels for the receipt of information on wires and cables. What previously may have required a cable tie and a placard about 1.5 inches long by ¾ inch wide, is now replaced by a small round surface of just over ½ inch in diameter. The label size for stick-on QR labels is about 15 mm×15 mm and can be of such materials as paper, polyester or Mylar® among others. Blank labels are available pre-cut on 8.5×11 inch sheets of paper for printing on an office inkjet printers Indeed even hand held QR code printers are also available. See for example the Brother® International QL line of printers among others that retail for as low as $60.00. Other vendors of QR code label printers include Zebra™ and Datamax for higher priced units. The QR or other coded tab 30 may be applied to the flat surface of the engaging portion of the notator, either prior to or subsequent to the placement of wire/cable in the device and the engagement of the two portions.

As mentioned above, FIG. 19 depicts a typical prior art QR code symbol while a typical prior art data matrix code symbol is shown in FIG. 20. Further discussion on the distinctions of the two code symbol systems is beyond the purview of this patent application since the invention herein only makes uses of them in a specialized format, self adhesive small tabs.

It is seen that applicant has uncluttered locations where a plethora of cable and wires are located by allowing each such cable or wire to carry its own small identifying information badge of honor for quick easy machine reading. In addition to cables, odd shaped parts for machinery, and the medical instrument industry as well as prostheses can be readily identified as to size shape, intended use and more by the encircling of such items with a tag of this invention carrying a 2D bar code symbol.

The notator devices of this invention may be provided in various materials, and in various colors which themselves can be used as an identifier such as of voltage, room in a building etc. as a secondary source of information over and above the QR or data matrix code message. Typical materials useful for these devices includes, nylon, polypropylene and polyethylene among other resins.

While the size shown and the bulk of the discussion has been on the use of micro-QR code labels of about 0.5 inch×0.5 inch, standard QR labels can also be attached to larger sized devices of the invention. In the alternative the receiving portion 11 can be maintained as shown, but the diameter of the base 22 of the engaging portion can be increased to accommodate the receipt of larger printed tabs of standard QR size. Data matrix symbols can be made in both QR size and in micro Qr size for attachment to the notators.

It is to be understood, that if a cable is rerouted, or changes made to one or more wires in the slot 31-33 of the notator, that the device of this invention can be removed by urging the two portions apart. One can accomplish this by use of the finger nail, or optional screwdriver or other pressure applying device. In such instance either a new device with an updated 2D bar code marking code symbol can be attached to the cable or with slight difficulty the tab removed and replaced by a new coded tab being applied to the notator. However due to a low cost factor, and to avoid errors as to whether the old tab was removed and the new one placed on the notator, “throw away and replace” is the preferred modus operandi.

As mentioned supra, the QR or data matrix code tab of this invention will recite information about the cable or wires or other item to which it is attached. Such information can include both near end (proximal) and far end (distal) information. Typically such information for cables and wires would be the building or building # if within a complex, floor, cubicle or closet, cabinet, and down to shelf and port. Other information can also be encoded such as circuit description, or functionality, such as Human resources Dept, or Accounting, or anything else desired by the users.

For larger items, such as automobile components, gears, prostheses and other irregular shaped items, the notator bearing the codes information can be encircled on the item to be identified to indicate, car model, location of attachment such as left or right; for prostheses, the size of the unit the weight carrying capacity, the gender for whom intended and other information can be placed in the symbol placed on the notator.

While QR code generators exist in the marketplace, there may be an initial learning curve to be able to code the tabs used on this device for the information desired by the user of these devices. It may be easier for the end user to utilize a cable or wire specific code generator from applicant with a pointer to a specific database managed by applicant or the end user that will allow for quick and easy generation of the tabs needed for the specific use of the customer. Applicant's assignee will complete a frame or shell of code such that an application for specific wire and cable information can be generated by the customer, as opposed to a computer program relating to the contents of a box of men's shirts. The same is true for all other items to be identified by tab carrying notators. That is, a partial computer program will be offered by applicant's assignee, into which the specific data of the customer is to be entered for ultimate tab make up.

While the discussion above has dealt with tabs that carry a self adhesive layer thereon, and clearly the use of such tabs is preferred, no reason is seen why a cloth or paper or plastic film tab to which adhesive is added separately can not be utilized to carry the indicia of the 2D bar code information.

It is to be seen that there are advantages in certain situations for using the device with the junction member and certain advantages to using the device embodiments without the junction member. In crowded IT areas, where space is at a premium, the lack of junction members can be very advantageous in close quarters in the identification of various wires and cables. On the other hand, for consumers the presence of the junction member is beneficial since it helps prevents loss of parts and thus waste of an entire device if one half gets lost or misplaced, and the junction member is beneficial for those with arthritis and Parkinson's disease, and non-nimble fingers.

Since certain changes may be made in the above devices without departing from the scope of the invention herein involved, it is intended that all matter contained in the above description and shown in the accompanying drawings shall be interpreted as illustrative and not in a limiting sense.

1. A notator device carrying QR/micro QR/data matrix indicia concerning the wire(s)/cable or other item, which wires/cable or other item is/are to be disposed in the notator,
said device comprising a first 2D bar code indicia bearing engaging portion and a second cup like shaped receiving portion for disposition on wires/cable, wherein the receiving portion is fixedly attached to the first or indicia carrying engaging portion by a junction member which receiving portion is matingly engage able with the engaging portion for retaining wires/cable or other item therein, and which device provides information about the nature of function or location of the wires/cable or other item from an indicia bearing tab disposed on the engaging portion.

2. The notator device of claim 1 wherein the engaging portion has a flat outer surface and the QR/micro QR/data matrix code is printed on a self adhesive tab attached to the outer surface of the engaging portion of the device.

3. The notator of claim 1 wherein the receiving portion of this device comprises a cup-like portion having a disc base and two upstanding spaced side wall segments, each of which has a semi-circular base which side wall bases are attached to the disc base along their respective diameters.

4. The notator of claim 3 wherein each wall segment of the receiving portion has an outward extending top lip, and each lip has an arcuate side surface and a horizontal bottom surface normal to the wall.

5. The notator device of claim 1 wherein the junction member has a first shorter rod like segment that is attached flexibly to the outside surface of the receiving portion at about the midpoint of the elevation thereof and a longer flexible rod like member connected on one end to the shorter rod like member spaced up from the distal end thereof and which junction member is disposed at an angle of about 120 degrees, and the other end of the longer rod like member is connected at the base of the engaging portion.

6. In the notator of claim 3 wherein each of the two sidewall segments of the receiving portion are arcuate in cross section, and each has an outward extending lip, and the item to which the 2D bar code indicia pertains is to be retained within the receiving portion.

7. The notator device of claim 1 wherein the receiving portion of this device comprises a cup-like portion having a disc base and two upstanding spaced side wall segments, each of which has a semi-circular base which side wall bases are attached to the disc base along their respective diameters.

8. in the notator device of claim 1 wherein the engaging portion has a flat circular base having a central annulus shaped segment on its inner surface, and a second flat area also round in configuration outside the annulus, and spaced from the second flat area at the outer edge of the base is a series of upstanding spaced wall segments each with an inward extending lip at the top thereof.

9. In the notator device of claim 8 wherein there are eight upstanding wall segments in the receiving portion, each of which is arcuate.

10. The notator device of claim 5 wherein the junction member is attached to the engaging portion at a location between spaced two wall segments.

11. In the notator device of claim 6 wherein the outward extending lip of the two wall segments has an arcuate side surface and a horizontal bottom surface normal to the respective wall segment.

12. In the notator device of claim 11 wherein one outward extending lip has an interruption space therein to permit the shorter rod like member of the junction member to fit flush against the wall segment when the two portions of the device are engaged.

13. In the notator device of claim 3 wherein the bi-sector of each the two spaces between the two upstanding spaced side wall segments of the receiving portion is a diameter line of the circular base of said receiving portion.

14. A process for identifying wire(s)/cable or other items to be disposed in a notator having a cup-like receiving portion and an engaging portion having a flat outer surface, the two portions being joined by a flexible junction member, which process comprises:
(A) placing the wire(s)/cable or other item in the cup like receiving portion of the notator,
(B) rotate the engaging portion and the receiving portions toward each other,
(C) matingly engage the two portions.
(D) apply a tab bearing QR/micro QR/or data matrix code with identification information concerning the wire(s)/cable or other item in said notator to the flat outer surface of said engaging portion.

15. In the process of claim 13 wherein step (D) is carried out prior to steps (A), (B) and step (C) and the tab is a self adhesive tab.

16. A notator device carrying 2D bar code indicia concerning the wire(s)/cable, which wires/cable are to be disposed in the notator,
said device comprising a first 2D bar code indicia bearing engaging portion and a second cup like shaped receiving portion for disposition of wires/cable, wherein the receiving portion is fixedly attached to the first or indicia carrying engaging portion by a junction member which receiving portion is matingly engage able with the engaging portion for retaining wires/cable therein, and providing information about the nature of function or location of the wires/cable,
wherein the receiving portion of this device comprises a cup-like portion having a disc base and two upstanding spaced side wall segments, each of which has a semi-circular base which side wall bases are attached to the disc base along their respective diameters,
and wherein the engaging portion has a flat circular base having a central annulus shaped segment on its inner surface, and a second flat area also round in configuration outside the annulus, and spaced from the second flat area at the outer edge of the base is a series of upstanding spaced wall segments each with an inward extending lip at the top thereof,
the 2D bar code indicia being a self adhesive tab disposed upon the outer surface of the engaging portion.

17. The notator device of claim 16, wherein the two portions are connected by a flexible junction member one of which is attached to each portion.

18. The notator device of claim 17 wherein the junction member has two rod like members linearly aligned.

19. In the notator device of claim 8 wherein there are eight upstanding wall segments in the receiving portion, each of which is arcuate and further including a circular rim that extends away from said base in a direction opposite said wall segments.

20. A notator device carrying QR/micro QR/data matrix indicia concerning the wire(s)/cable or other item, which wires/cable or other item are to be disposed in the notator,
said device comprising a first 2D bar code indicia bearing engaging portion having interrupted wall segments and a base, and a second cup like shaped receiving portion for disposition on wires/cable, wherein the receiving portion is fixedly attached to the first or indicia carrying engaging portion by a junction member which receiving portion is matingly engageable with the engaging portion for retaining wires/cable or other item within the engaging portion,
wherein the base of said engaging portion has one surface which faces opposite the wall segments thereof and has a circular rim on said base extending away form said wall segments,
which device provides information about the item being carried therein on a 2D bar coded tab disposed within said rim.

21. The notator device of claim 20, further including a clear protective disk disposed over the indicia carrying tab within said rim.

22. The notator device of claim 2 further including a clear cover layer disposed over said tab.

23. A process for identifying wire(s)/cable or other items to be disposed in a notator having a cup-like receiving portion and an engaging portion having a flat outer surface with a circular rim that extends normal to said surface, the two portions being joined by a flexible junction member, which process comprises:
(A) placing the wire(s)/cable or other item in the cup like receiving portion of the notator,
(B) rotate the engaging portion and the receiving portions toward each other,
(C) matingly engage the two portions.
(D) apply a tab bearing QR/micro QR/or data matrix code with identification information concerning the wire(s)/cable or other item in said notator to the flat outer surface of said engaging portion within said rim.

24. The process of claim 23 further including the step of applying a clear cover layer over said tab to protect the tab's indicia.

25. A notator device carrying QR/micro QR/data matrix indicia concerning the wire(s)/cable or other item, which wires/cable or other item are to be disposed in the notator, said device comprising a first 2D bar code indicia bearing engaging portion having interrupted wall segments and a base, and a second cup like shaped receiving portion for disposition on wires/cable, wherein the receiving portion is matingly engagable with the engaging portion for retaining wires/cable or other item within the engaging portion, wherein the base of said engaging portion has one surface which faces opposite the wall segments thereof and has a circular rim on said base extending away form said wall segments,
which device provides information about the item being carried therein on a 2D bar coded tab disposed within said rim.

26. A notator device carrying QR/micro QR/data matrix indicia concerning the wire(s)/cable or other item, which wires/cable or other item is/are to be disposed in the notator,
said device comprising a first 2D bar code indicia bearing engaging portion and a second cup like shaped receiving portion for disposition on wires/cable, wherein the receiving portion is matingly engagable with the engaging portion for retaining wires/cable or other item therein, and which device provides information about the nature of, function or location of the wires/cable or other item, the 2D bar code indicia being on a tab disposed on the engaging portion.

27. The notator device of claim 25, further including a clear protective disk disposed over an indicia carrying tab within said rim and the 2D bar code is data matrix code.

28. The notator device of claim 26 further including a clear cover layer disposed over an indicia carrying tab disposed on said engaging portion and said 2D bar code is data matrix code.

29. The process of claim 23, wherein step (D) comprises, peeling a cover layer from a self adhesive tab and pressing the tab into proper position.

30. A process for identifying wire(s)/cable or other items to be disposed in a notator having a cup-like receiving portion and an engaging portion having a flat outer surface with a circular rim that extends normal to said surface, the two portions not being joined together which process comprises:
(A) placing the wire(s)/cable or other item in the cup like receiving portion of the notator,
(B) rotate the engaging portion and the receiving portions toward each other,
(C) matingly engage the two portions.
(D) apply a tab bearing QR/micro QR/or data matrix code with identification information concerning the wire(s)/cable or other item in said notator to the flat outer surface of said engaging portion within said rim.

31. The process of claim 30, further including the step of applying a clear cover layer over said tab to protect the tab's indicia
